(19) United States
(12) Patent Application Publication
(10) Pub. No.: US 2015/0142674 A1
(43) Pub. Date: May 21, 2015

(54) SYSTEM AND METHOD FOR GENERATING AND FINALIZING A REQUEST FOR SALE

(71) Applicant: NABTHAT, INC., Los Angeles, CA (US)

(72) Inventor: Jason Silberberg, Los Angeles, CA (US)

(73) Assignee: NABTHAT, INC., Los Angeles, CA (US)

(21) Appl. No.: 14/083,298

(22) Filed: Nov. 18, 2013

(51) Int. Cl. G06Q 30/06; G06Q 50/18

(52) U.S. Cl. CPC G06Q 30/0611; G06Q 50/188
USPC 705/80

(57) ABSTRACT

A system and related method are provided to generate and finalize a request for sale (RFS). The system controls commerce between buyers and sellers, which is transmitted over a communication network and initiated and driven by buyer bids. In a preferred embodiment, the system allows buyers to research products and financing terms, decide on a price they would like to pay for a product, and communicate an RFS either globally to all available sellers or to a select number of filtered sellers. The system then transmits the offer to appropriate sellers. The sellers have the option to accept a buyer's RFS or to counter the RFS with different parameters. When a purchase price has been accepted, a request for sale is finalized and a non-binding agreement to purchase terms is established.

### FIELD OF THE INVENTION

The present invention relates generally to a system and related method for purchasing goods and, more particularly, a system that allows a buyer to make an offer to buy a product and allows sellers to accept or counter an offer.

### BACKGROUND OF THE INVENTION

Purchasing products, such as cars, insurance, and the like, is a significant transaction in the average consumer's lifetime. Such product purchase can be complex, with many terms and conditions that must be considered. However, the purchasing process often hinders the consumer from adequately accounting for all such terms.

For example, the process for completing an automobile purchase is typically handled in-person, in which a consumer goes into a car dealer and negotiates with a salesperson. Some car dealers may attract more customers than others, but the popular dealers may not necessarily have the best prices or terms, disadvantaging both the consumer and the less popular dealerships.

The price of a given make and model of car may vary by hundreds to thousands of dollars between dealers, making comparison-shopping a vital part of the process. This can be a time-consuming and costly process, as dealers are spread widely across metropolitan areas. Further, the consumer may find it uncomfortable to haggle with multiple dealers and, consequently, leave empty-handed.

More recently, websites are now available for consumers to do research regarding automobile pricing. Some websites provide consumers with “fair price” data for a current market. However, with these sites, the seller has made no agreement to adhere to the displayed price, and it is still up to the consumer to shop this figure around to various dealers. Further, such prices typically do not include the myriad of additional costs involved in purchasing a car, such as taxes, licensing fees, and financing charges.

Some sites offer consumers the ability to receive a quote from multiple dealers based off an MSRP. These quotes are generated either through some algorithm or through anonymous interaction with multiple dealerships whereby consumers can counter dealer's offers. These sites are free to consumers and charge a commission to dealers. They are considered lead generators since they do not have any interaction once the consumer and dealer physically meet.

It should, therefore, be appreciated that there exists a need for a system that allows a consumer to determine an appropriate price for a given car and make an offer, which can then be accepted by one or more dealers.

### SUMMARY OF THE INVENTION

Briefly, and in general terms, a system and related method for conducting a transaction is provided that purveys a purchaser interface and a seller interface to enable communication therebetween. The purchaser makes an anonymous offer and one or more anonymous sellers can then accept that offer or make a counteroffer. Upon mutual acceptance of purchase terms, a non-binding agreement is created regarding price and the product, which will be used to create a binding sale agreement at a future time such as a contract.

In a detailed aspect of an exemplary embodiment, the purchaser generates a request for sale (“RFS”). An RFS is a non-binding presentation of acceptable terms for purchase of a product that can include pricing terms and specific features for the product. The price can account for all additional fees such as tax, license, and registration. With the pricing already accepted by the seller, the purchaser can go to the appropriate dealership, complete the transaction, and take possession of the car.

In another detailed aspect of an exemplary embodiment, for an automotive purchase, the buyer can choose a make and model of a vehicle and additional options such as a navigation system, color, trim, etc. The buyer has the option to select whether to lease a car, purchase it with financing, or purchase it without financing. If necessary, the buyer can select the down payment, monthly payment, and other necessary financing terms. The lease terms can include lease terms, including monthly payment, annual mileage, and lease duration, as well as other terms used in automobile leasing. The user can select to run a credit check, manually enter a credit score, or bypass a credit check. The system then generates a credit grade that is provided to dealers based on the users credit score.

For example, in an exemplary embodiment, if the first interaction between a bid and a seller is an “accept” before any “counter” is made than the bid is locked to that specific seller. Therefore, if a dealer accepts immediately before any other dealer interacts with a bid than it is locked. The deal is valid for only a set period.

In another detailed aspect of an exemplary embodiment, a seller can elect to be notified of new RFSs that the seller is eligible to accept and/or browse existing available RFSs. The seller interface also allows dealers to filter out requests for sales. For example, a dealer can require that certain models of cars can only be requested by consumers with a credit score above a certain threshold. As a default, an RFS is sent to all dealers within a certain radius, who then have the option to accept or counter a given bid. Once a bid is accepted by both the buyer and the seller, the deal is completed. Information is sent to both parties and they are encouraged to contact each other. At this point, the buyer can go to the dealer, sign the papers, and the purchase is complete.

In a detailed aspect of an exemplary embodiment, all interactions between buyer and seller are anonymous until the RFS has been accepted by both parties, and then information is sent about one party to the other.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a block diagram overview of a system for generating and finalizing a request for sale in accordance with the invention.

FIG. 2A is a block diagram of the central controller for the system of FIG. 1.

FIG. 2B is a block diagram of the buyer interface for the system of FIG. 1.

FIG. 2C is a block diagram of the seller interface for the system of FIG. 1.

FIG. 3 is a flow chart of a system for generating and finalizing a request for sale for the system of FIG. 1.

FIG. 4 is a flow chart showing the consumer-end process for the system of FIG. 1.

FIG. 5 is a screen shot of an exemplary user interface for selecting a product for the system of FIG. 1.

FIG. 6 is a screen shot of an exemplary user interface for bidding on a product for the system of FIG. 1.

FIG. 7 is a flow chart of the buyer submitting an initial RFS for the system of FIG. 1.

FIG. 8 is a flow chart of the process for routing an RFS to potential sellers for the system of FIG. 1.

FIG. 9 is a flow chart of the process for checking for an expired RFS for the system of FIG. 1.

FIG. 10 is a flow chart showing the seller-end process for the system of FIG. 1.

FIG. 11 is a screen shot of an exemplary dealer dashboard for the system of FIG. 1.

FIG. 12 is a flow chart of the seller RFS initiation process for the system of FIG. 1.

FIG. 13 is a flow chart of the seller RFS selection process for the system of FIG. 1.

FIG. 14 is a flow chart of the process for a buyer to view a counter RFS for the system of FIG. 1.

FIG. 15 is a flow chart of the process for a buyer to respond to a counter RFS for the system of FIG. 1.

FIG. 16 is a flow chart of the process for checking if the RFS limit has been reached for the system of FIG. 1.

### DETAILED DESCRIPTION OF THE PREFERRED EMBODIMENTS

In this section, the present invention is described in detail with regard to the figures briefly described above. As such, the following terms are used throughout the description. For purposes of construction, such terms shall have the following meanings:

As used in this application, the terms “system” and “central controller,” unless otherwise specified, are intended to refer to a computer-related object, such as hardware, software, or a combination of hardware and software. For example, a system may be, but is not limited to being, a process running on a processor, a processor, an object, an executable, a thread of execution, a program, and a computer. By way of illustration, both an application running on a server and the server can be a system. One or more systems may reside within a process and/or thread of execution and a system may be localized on one computer and/or distributed between two or more computers. Those skilled in the art will further appreciate that the depicted flow charts may be altered in a variety of ways. For example, the order of the steps may be rearranged, steps may be performed in parallel, steps may be omitted, or other steps may be included.

When the term “accessing,” unless otherwise specified, is used in connection with accessing data or accessing characteristics or accessing other items, it is not limited to accessing data or information from outside the processor, but instead would include all such items accessed within the data processing apparatus or system, or from sources external to the processor.

The terms “buyer,” “customer,” “consumer, and “user,” unless otherwise specified, are intended to refer to any person, group of people, business, government entity, government-related entity, or other organization that uses the system to buy goods or services.

The terms “seller,” “dealer,” and “dealership,” unless otherwise specified, are intended to refer to any person, group of people, business, government entity, government-related entity, or other organization that uses the system to sell products, to include goods or services.

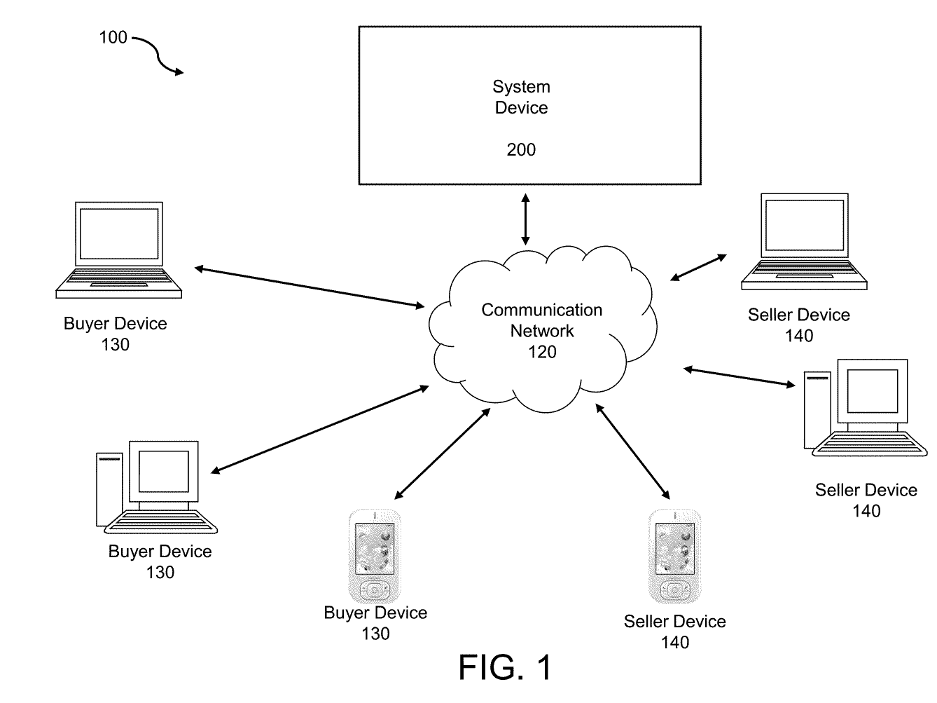

Referring now to the drawings, and particularly FIG. 1, there is shown a simplified block diagram of a system for generating and finalizing a request for sale 100. The system device 200 comprises a plurality of components linked with one another, with buyer devices 130, and with seller devices 140 through a communication network 120. The communication network could be the internet, a local area network (LAN), or any other type of network. Connections between components are shown using double-sided arrows, which may be physical, fiber optic, wireless, or any other type of communications link.

Multiple buyer devices 130 and seller devices 140 may be connected to the system at a given time. The devices could be computers, wireless or wired phones, personal data assistants (PDAs), tablets, or other devices capable of handling and transmitting data.

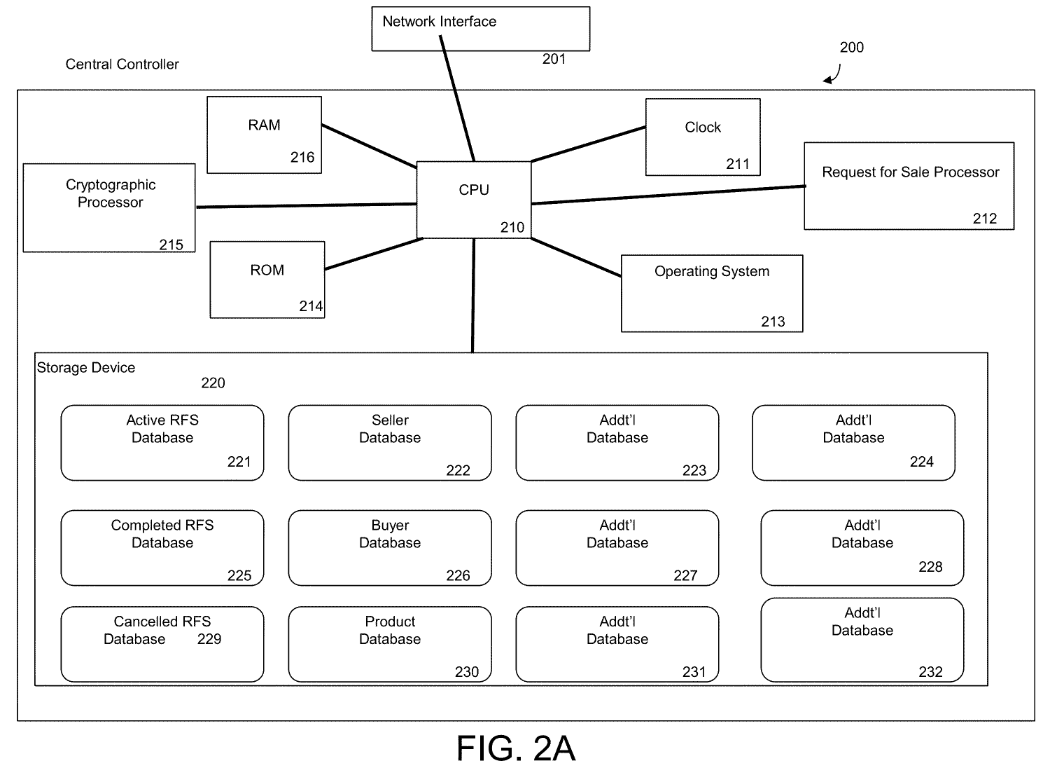

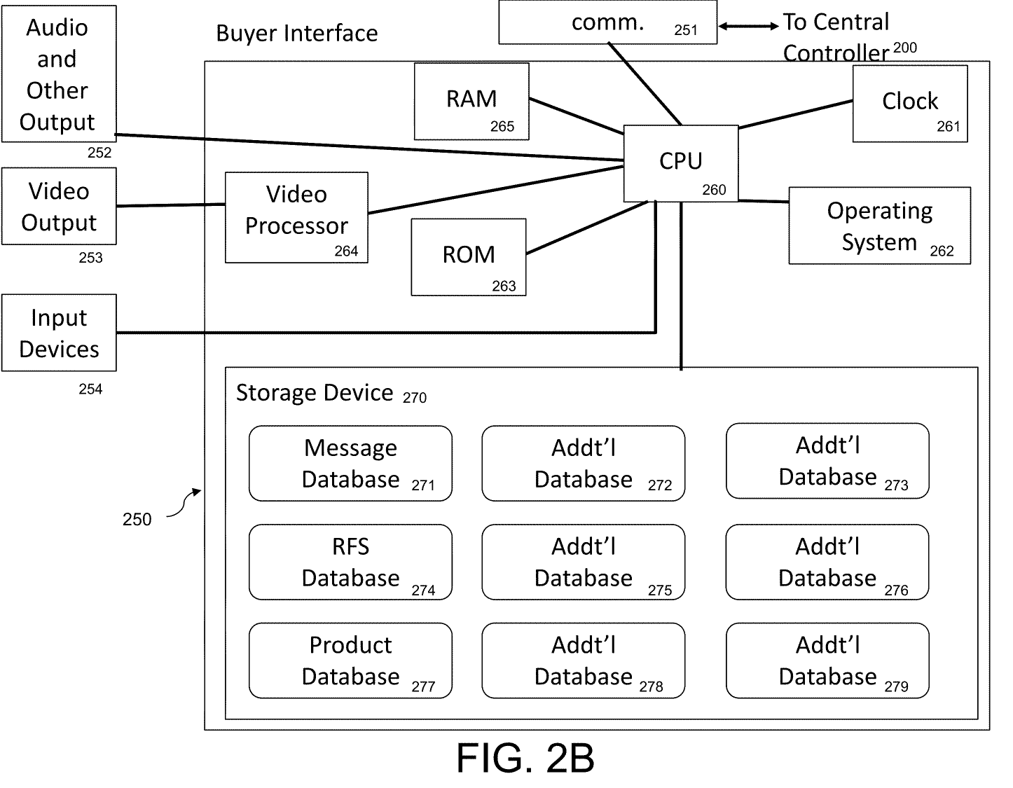

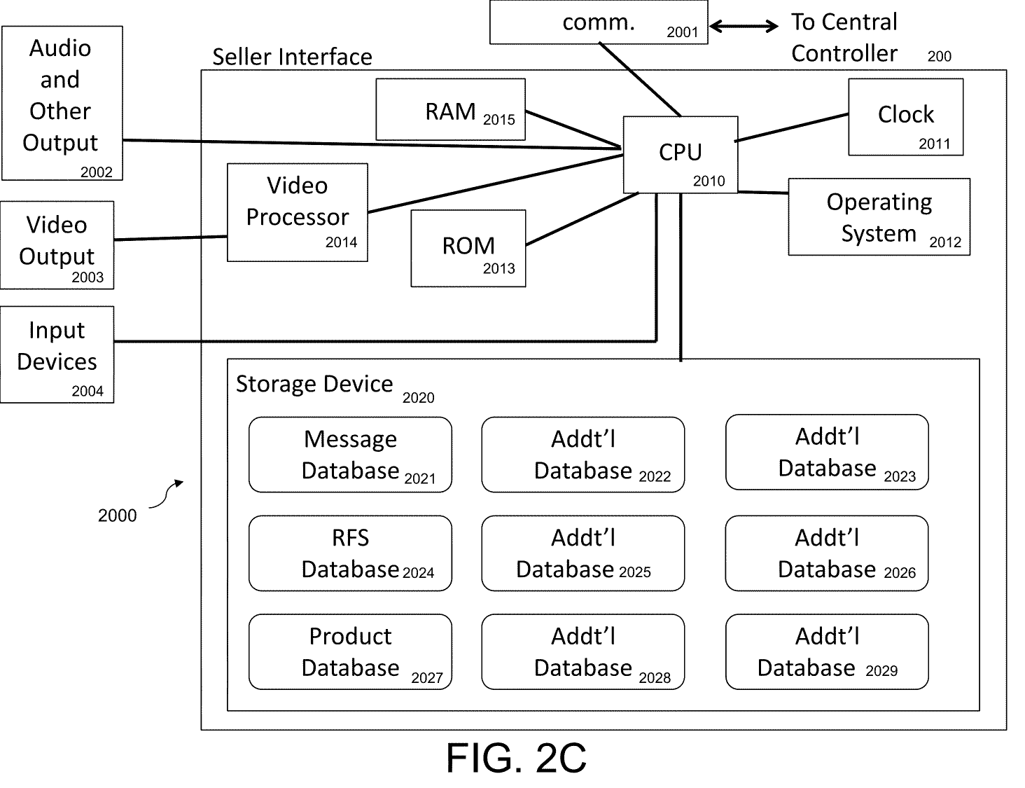

With reference to FIG. 2A, there is shown a block diagram of the central controller 200. A network interface 201 connects the central controller to buyers and sellers via a wireless link, physical wires, or any other type of communications link. A CPU 210 controls the process. Random access memory (RAM) 216 stores data and instructions. The device also includes a cryptographic processor 215, a memory storage device such as read-only memory (ROM) 214, an operating system 213, a processor 212, and a clock 211. The system 200 receives information through the network. In response, it executes instructions as provided in one or more sequences.

Computer system 200 also includes a memory storage device 220, such as read-only memory, a magnetic storage disk, an optical storage disk, or other non-transitory memory storage devices. Pluralities of databases are stored in the storage device (s) 220. An active RFS database 221 stores RFSs that are open and unexpired and a completed RFS database stores RFSs that are completed. Seller database 222 stores information about registered sellers and buyer database 226 stores information about registered buyers. A product database 230 stores information about the various goods available on the system. Additional databases 223, 227, 231, 224, 228, 232 store other necessary information.

With reference to FIG. 2B, there is shown a block diagram of the buyer interface 250. CPU 260 connects to the central controller 200 through a communications 251. Buyers can enter information through input devices 254. Input devices include, for example, keyboards, scanners, recorders, phones, touch screens, mice, and any other type of device useable for providing input transferrable to the system in digital format. Buyers view information through video output 253 such as a screen, and/or audio and other output 252 such as speakers.

The CPU 260 includes a clock 261, an operating system 262, read-only memory (ROM) 263, a video processor 264, and random access memory (RAM) 265. The CPU stores information to a storage device 270 comprising a plurality of databases. A message database 271 stores messages to and from the buyer. An RFS database 274 stores requests for sale to the buyer. A product database 277 stores product information, and additional databases 272, 273, 275, 276, 278, 279 store additional information.

With reference to FIG. 2C, there is shown a block diagram of the seller interface 2000. The CPU 2010 connects to the central controller 200 through a communications device 2001. Sellers can enter information through input devices 2004. Input devices include, for example, keyboards, scanners, recorders, phones, touch screens, mice, and any other type of device useable for providing input transferrable to the system in digital format. Sellers view information through video output 2003 such as a screen, and/or audio and other output 2002 such as speakers.

CPU 2010 includes a clock 2011, an operating system 2012, read-only memory (ROM) 2013, a video processor 2014, and random access memory (RAM) 2015. The CPU stores information to a storage device 2020 comprising a plurality of databases. A message database 2021 stores messages to and from the seller. An RFS database 2024 stores requests for sale to the seller. Product database 2027 stores product information, and additional databases 2022, 2023, 2025, 2026, 2028, 2029 store additional information.

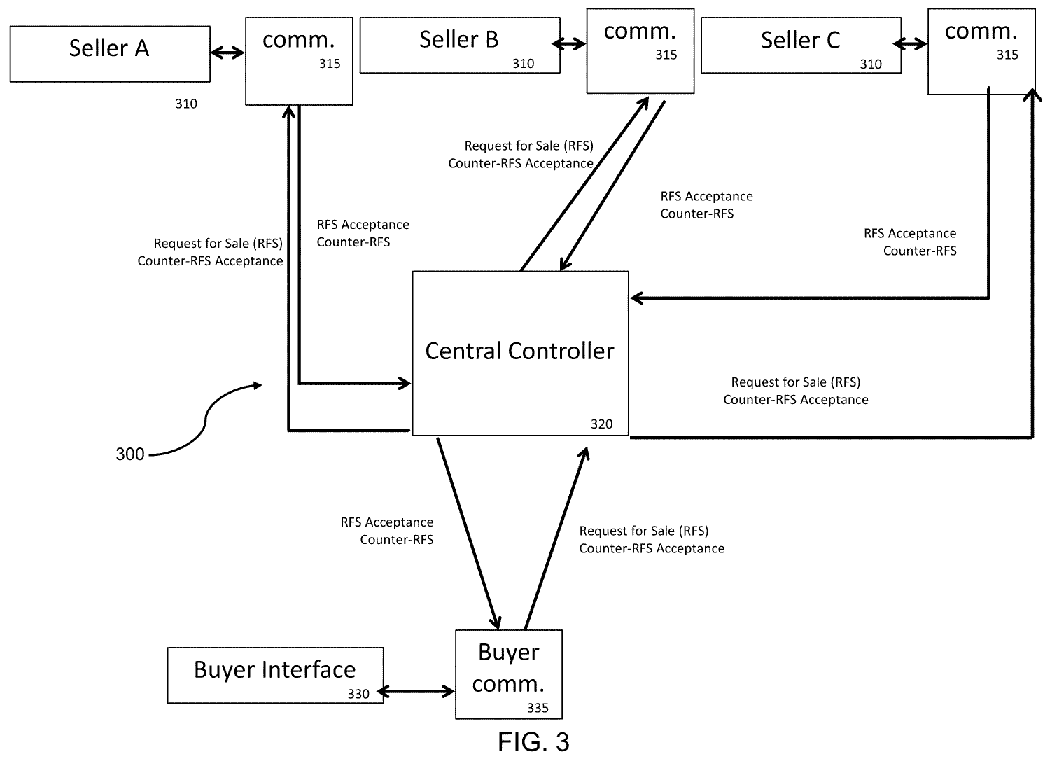

With reference to FIG. 3, there is shown a flow chart of the system for generating and finalizing an RFS. The seller interfaces 310 allows sellers to submit RFS acceptances or counter-RFS offers, which are transmitted through seller communications devices 315 via a communication network to a central controller 320. The buyer interface 330 allows buyers to submit an RFS, submit a counter-RFS, or accept an RFS. This may be done via a buyer communications 335, which transmits the request to a central controller 320 through a communication network.

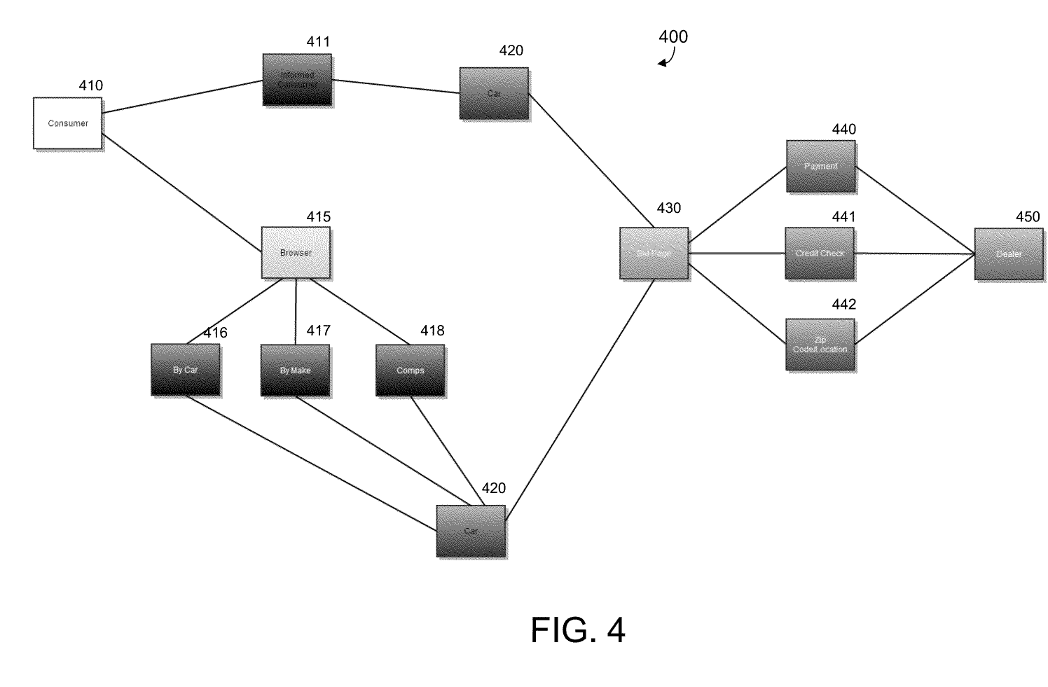

With reference to FIG. 4, there is shown a flow chart for the consumer-end process 400. The system enables a consumer 410 to research about the products, including features, terms, and pricing. In an exemplary embodiment, the product in question is a car 420. The browser 415 allows the user to select by make 416, model 417, and other features 418. After selecting a car 420, the buyer is directed to a bid page 430. At this point, there are options for payment 440, running a credit check 441, and entering a zip code to find the buyer's location 442. This information is can be used to select an appropriate dealer 450.

In the exemplary embodiment, the user can select to run a credit check, manually enter a credit score, or bypass a credit check. The system then generates a credit grade (e.g., credit identifier) that is provided to dealers based on the users credit score. The credit information is provided to sellers along with the RFS.

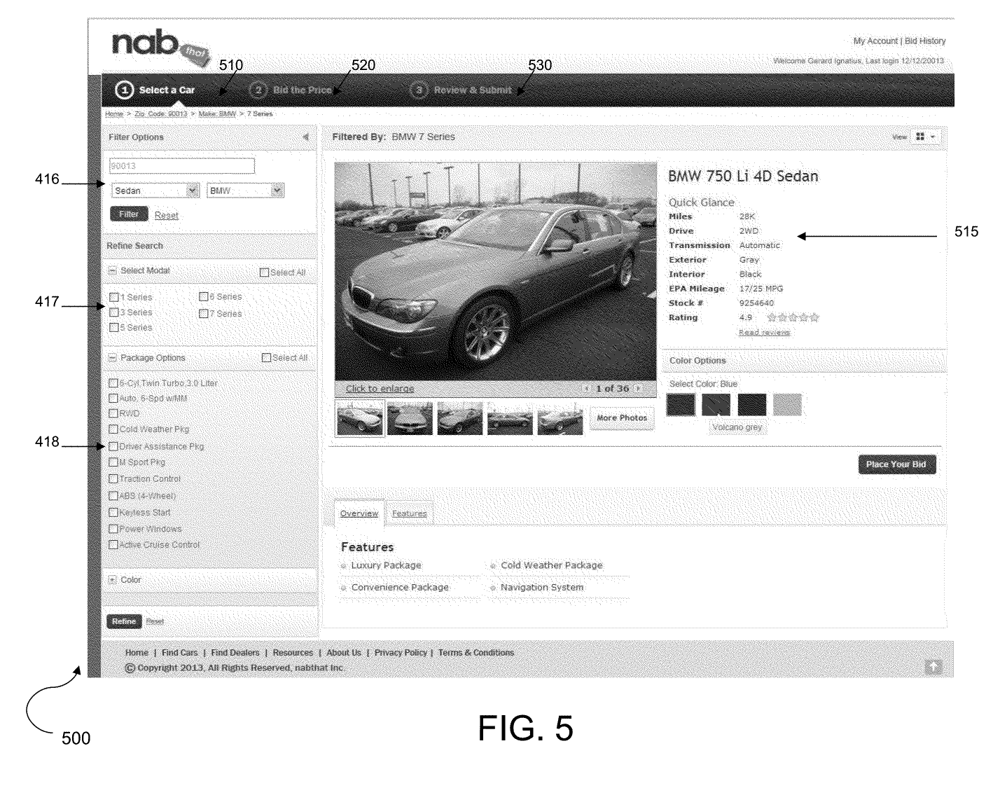

Referring now to FIG. 5, there is shown a screen shot of an exemplary user interface 500 when selecting a product. The user dashboard has four phases: select a product 510, bid the price 520, and review and submit 530. When selecting a car, for example, the user can select between makes 416, models 417, and other options 418. An image and other useful information 515 are then displayed. It is noted that the consumer need not conduct research on the site before placing a bid (RFS).

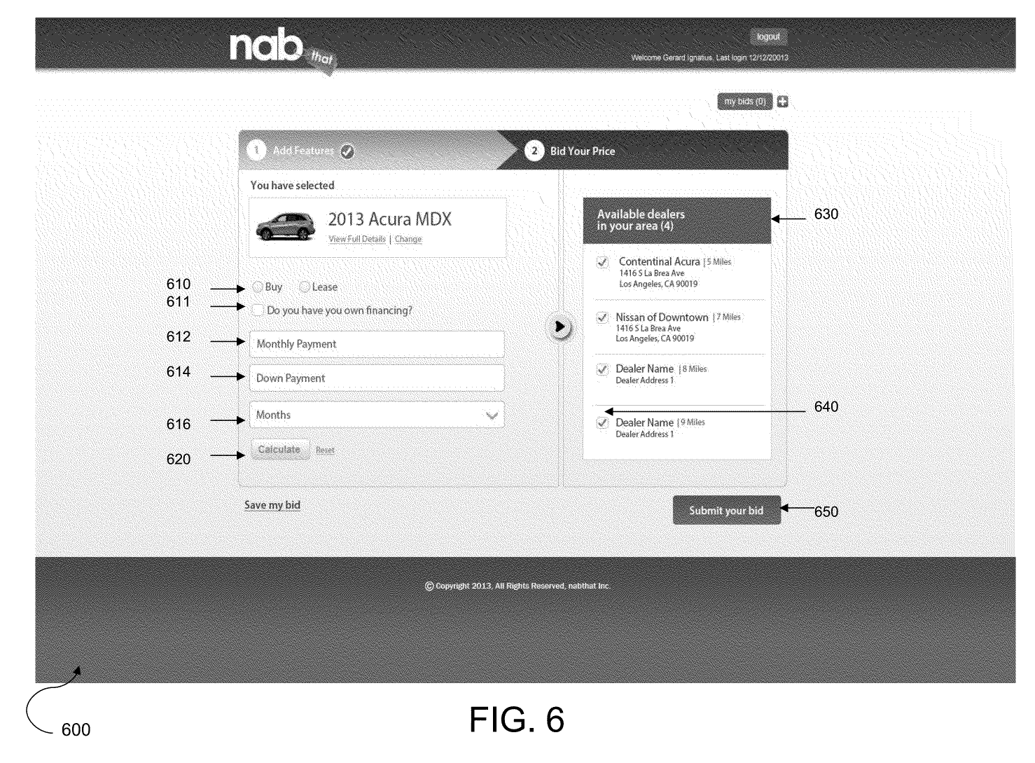

With reference to FIG. 6, there is shown a screen shot of an exemplary user interface 600 when bidding on a product. In the case of a car, there are the options to buy or lease the vehicle 610. The user then selects whether they have their own financing 611. If this option is not selected, the user chooses a monthly payment 612, down payment 614, and term 616. The user can then hit a calculate button 620 and a financing chart displays annual percentage rates (APR) and calculates a monthly price.

Using the buyer location, the system selects appropriate dealerships (sellers), for example, all dealerships within a 25-mile radius. The user is shown a list of available dealers in their area 630, along with their addresses and distances. The buyer has the option to manually uncheck certain dealers 640 or change the radius within which to display dealerships. After making the appropriate selections, the user submits the bid 650.

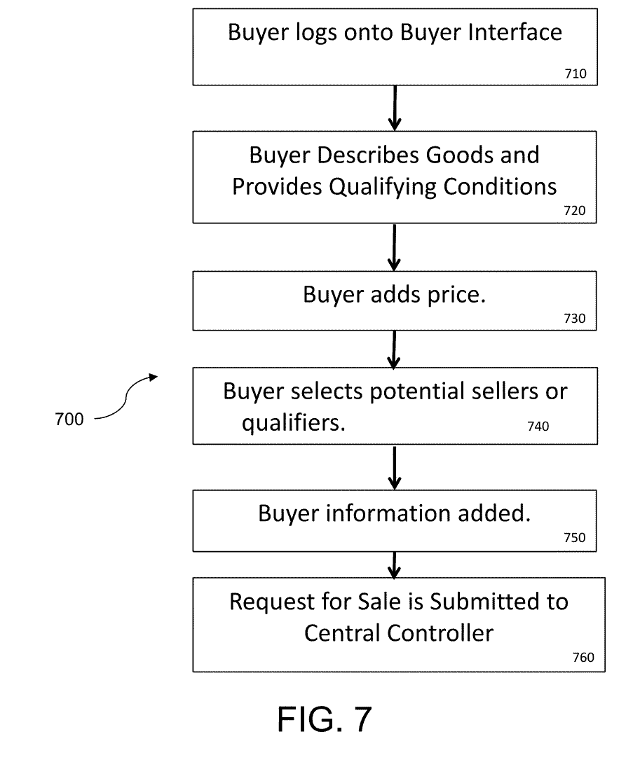

With reference to FIG. 7, there is shown a flowchart for RFS generation 700 by a buyer. First, the buyer logs on to the buyer interface 710. The buyer then describes goods and provides qualifying conditions 720. Next, the buyer enters a price 730 and selects potential sellers 740. The buyer enters identifying information 750. The completed request for sale is submitted to the central controller 760. After the RFS is submitted, it is stored within the system.

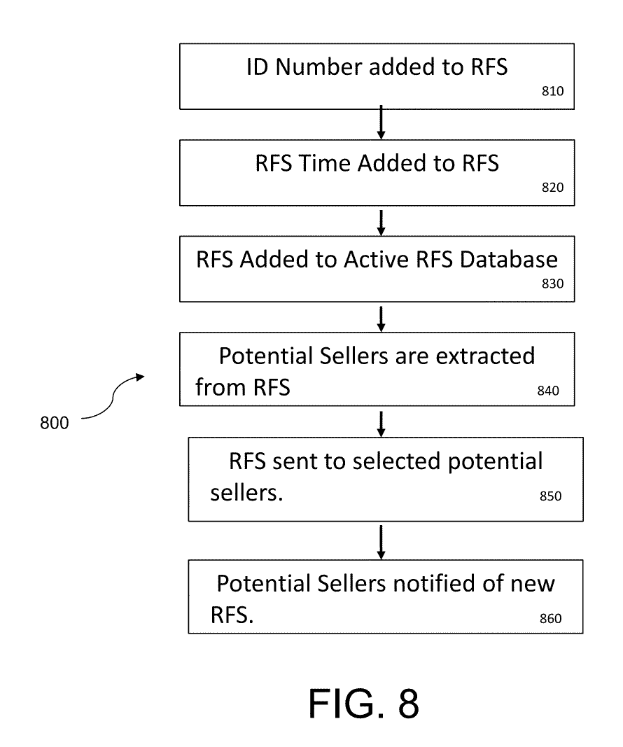

With reference to FIG. 8, there is shown a flowchart for RFS storage and routing 800 by the central controller. First, an ID number is added to the RFS 810. Then, the RFS is stamped with an RFS time 820. The system allows RFSs to be tracked by time and to expire after a set time. RFSs are also tracked by the number created per user, and the system allows for a limit on the number of RFSs a buyer can create. The RFS is then added to the active RFS database 830. The RFS is sent to selected sellers, determined by buyer and system parameters. Potential sellers are extracted from the RFS information 840, and the RFS is sent to the appropriate sellers 850. Potential sellers are notified when they receive a new RFS 860.

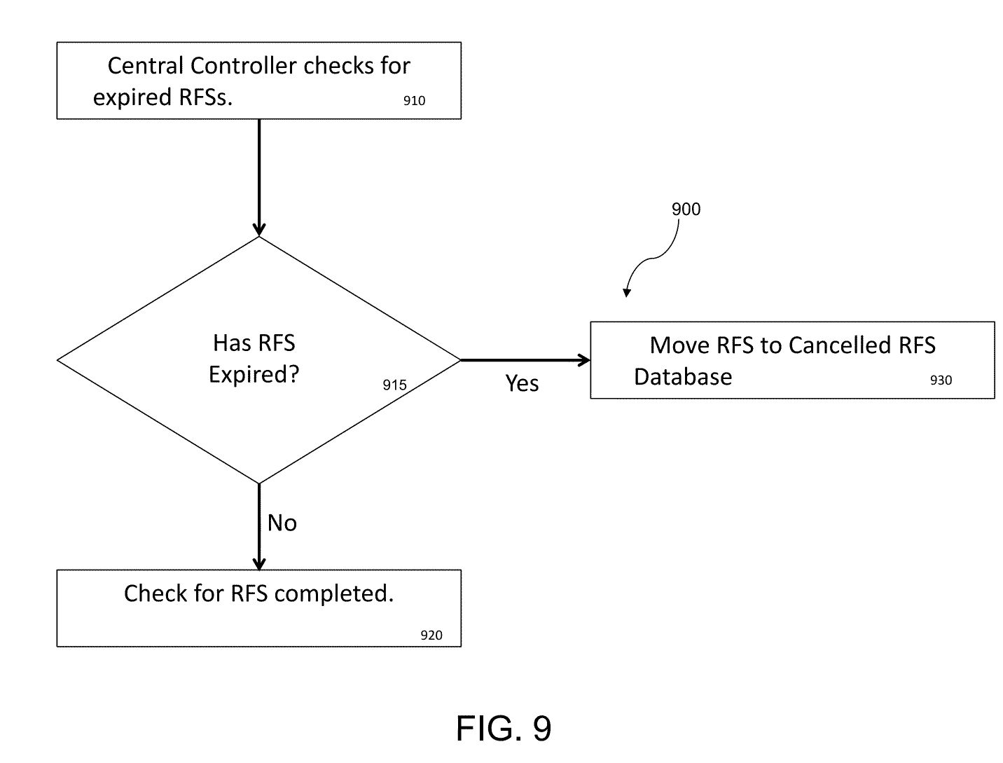

With reference to FIG. 9, there is shown the process to check for expired RFSs 900. The central controller checks for expired RFSs 910. If the RFS in question has expired 915, the RFS is moved to the cancelled RFS database 930. If the RFS in question has not expired, the expiry check is completed 920 and the RFS can proceed to the sellers.

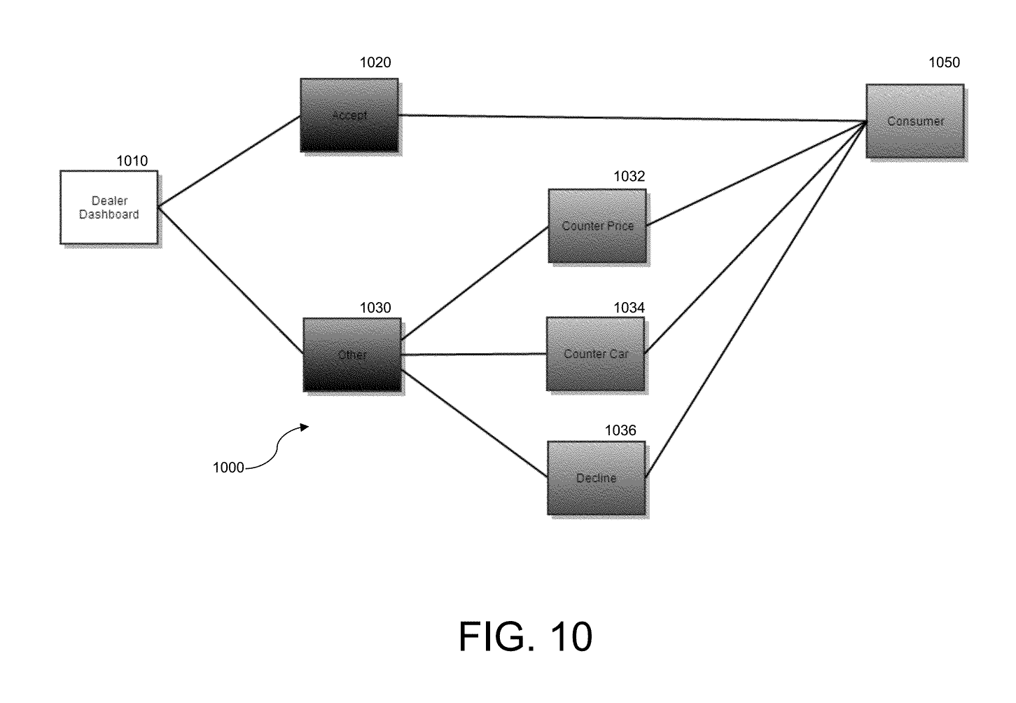

With reference to FIG. 10, there is shown a flow chart for the dealer dashboard process 1000. When a seller is selected by the system to receive an RFS, the system has the capability to notify the seller. These notifications can come through the internet as a message in a web portal, via an email communication, or via traditional communications such as a telephone call, text message, or regular mail. Upon notification of an RFS, sellers have the ability to respond to an offer in several ways. From the dealer dashboard 1010, a dealer has the option to accept an offer 1020. A dealer can accept an RFS so long as they can satisfy all dimensions of the request including price terms and product terms. If the dealer accepts an RFS, the RFS is removed from the list of available RFSs, effectively claiming the deal, and preventing other sellers from accepting the RFS. Acceptance of an RFS is available on a first-come basis, only allowing one seller to accept a particular RFS. A seller can accept an RFS either through the Internet or by using communication methods specified between the system operator and the seller, such as internet communication, telephone, standard mail, or other forms of communication. The acceptance is then transmitted back to the consumer 1050.

In the event a seller cannot fulfill a specific RFS, there are several other options 1030. The system has the capability to allow a seller to create a counter-offer or counter-RFS. In a counter-RFS, the seller can change the dimensions of the sale, either by changing the price 1032, changing the product 1034, or both. To use the automotive sale example, a seller could counter the product if they do not have the exact features a buyer requested. A seller may have a buyer's preferred car, but without the requested luxury package. The seller can then submit a counter-RFS showing the change in price terms and change in product terms—the car without the luxury package at a lower price. A seller can also decline the RFS 1036. The system takes the dealer input and transmits it to the consumer 1050.

In an exemplary embodiment, the system provides a prescribed limit for the number of RFSs and counter-RFSs, to deter bidding wars. However, a buyer is free to create as many “new” RFSs as the system's conditions allow.

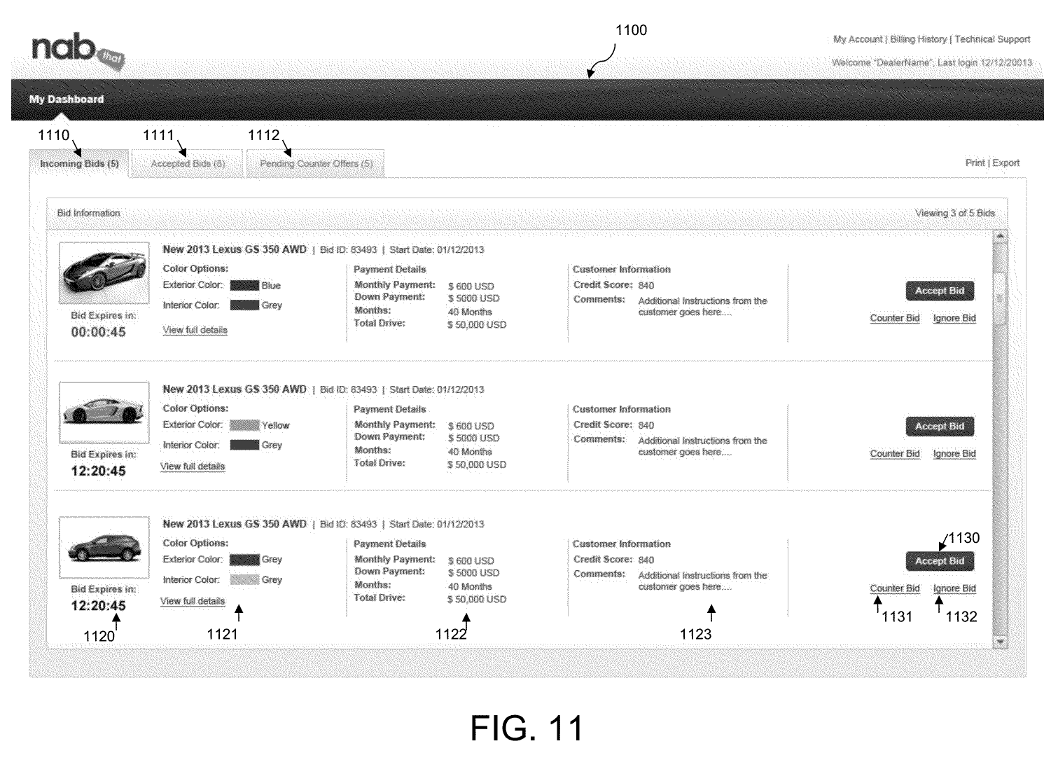

With reference to FIG. 11, there is shown an exemplary dealer dashboard 1100. The dealer can view incoming bids 1110, accepted bids 1111, and pending counter-offers 1112. For incoming bids, the dashboard shows how long until the bid expires 1120, the specifications of the car 1121, the payment details 1122, and consumer credit information and additional instructions 1123. The dealer can view this information and select whether to accept the bid 1130, counter the bid 1131, or ignore the bid 1132. The dealer can also filter out requests for sale. For example, a dealer can require that a prospective buyer have a threshold credit score in order to transmit a request for sale for a given model of car.

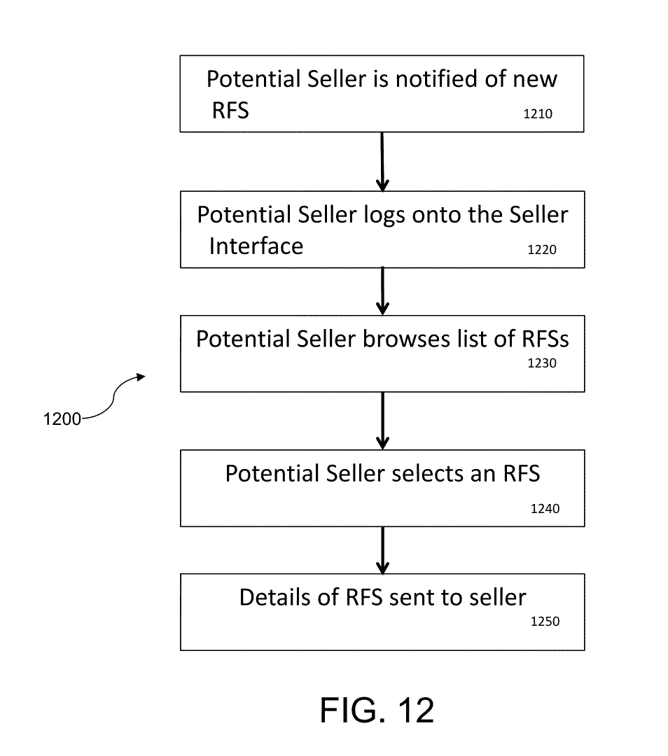

With reference to FIG. 12, there is shown a flow chart for the process for a potential seller to view available RFSs 1200. The potential seller is notified of a new RFS 1210. The seller then logs onto the seller interface and browses the list of RFSs 1230. When the seller selects an RFS 1240, the details of the RFS are sent to the seller 1250.

In certain embodiments, buyers cannot counter offers given to them by dealers. In this manner, the seller is incentivized to make the best counter they can since that is their one and only counter. Thus, the buyers will likely receive multiple counters and/or accepts, from which the buyer can pick which one suits them best, but they without the ability to counter.

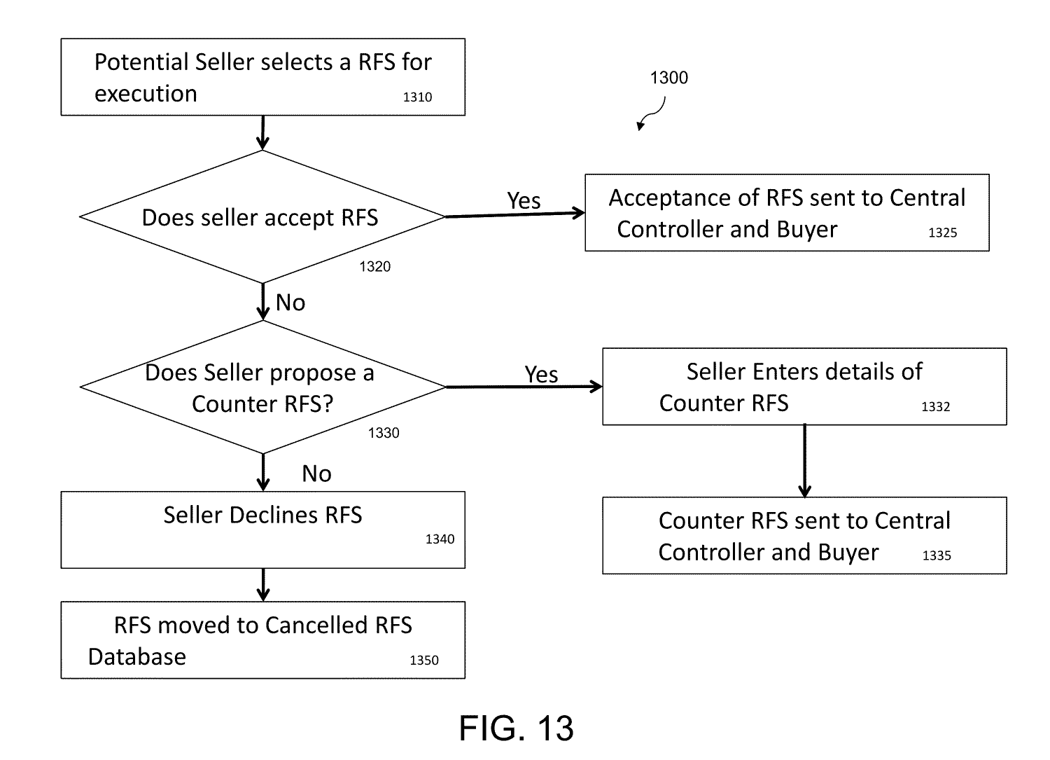

With reference to FIG. 13, there is shown a flow chart for seller actions when viewing an RFS 1300. First, a potential seller selects an RFS for execution 1310. If the seller accepts the RFS 1320, acceptance is sent to the central controller and the buyer 1325. If the seller proposes a counter RFS 1330, the seller is prompted to enter the details of the counter RFS 1332, and the counter is sent to the central controller and the buyer 1335. In the event that a seller submits a counter-RFS, the system allows the buyer's original RFS to remain active so that another seller may still accept it. The system allows buyers and sellers to create an unlimited amount of RFSs and counter-RFSs until an agreement is reached. If the seller declines the RFS 1340, then the RFS is moved to the cancelled RFS database.

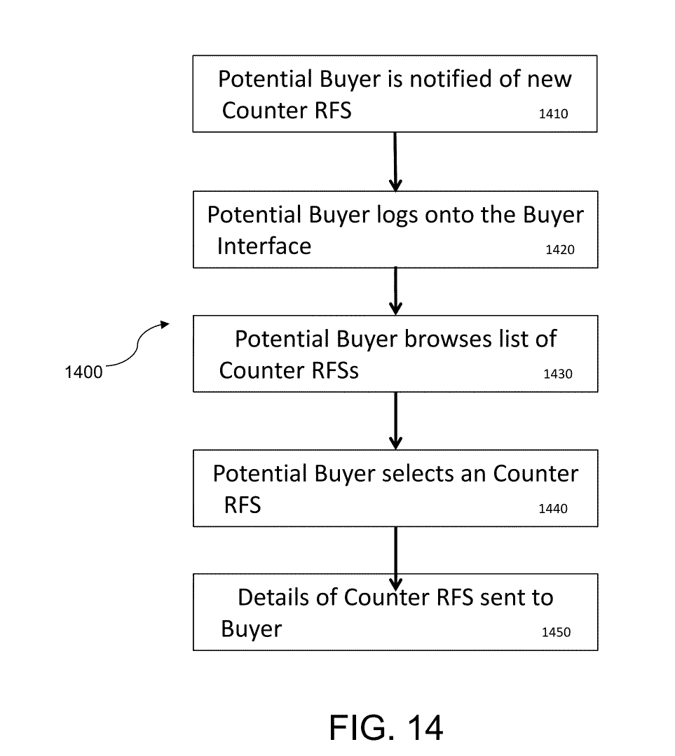

With reference to FIG. 14, there is shown a flow chart for the process for a buyer to view available counter-RFSs 1400. The potential buyer is notified of a new counter-RFS 1410. The potential buyer then logs onto the buyer interface 1420 and browses a list of counter RFSs 1430. After selecting a counter RFS 1440, the details are sent to the buyer 1450.

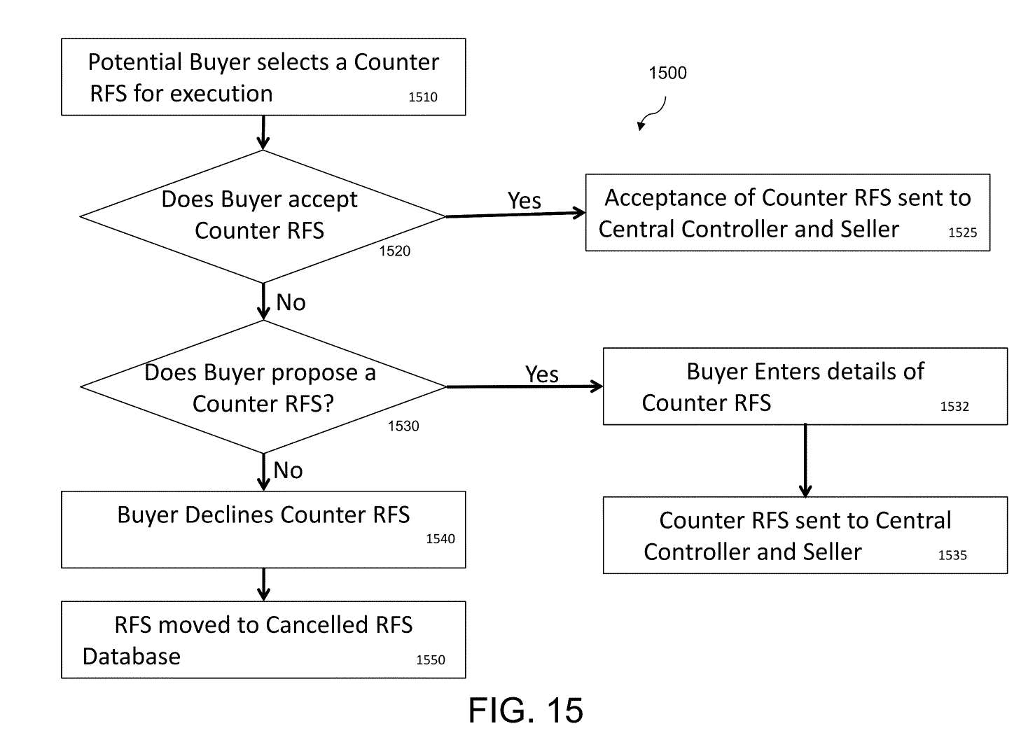

With reference to FIG. 15, there is shown a flow chart for buyer actions when viewing a counter-RFS 1500. First, a potential buyer selects a counter-RFS for execution 1510. If the buyer accepts the counter-RFS 1520, acceptance is sent to the central controller and the seller 1525. In the event of acceptance, the system will remove all RFSs created by said buyer for said product sale from the sellers' applications, preventing any additional sellers from accepting an RFS. Although potentially allowing buyers and sellers to create an unlimited number of RFS 's and counter-RFS 's, the system also has the capability to limit the number of RFSs and counter-RFSs based on seller, buyer, or system preferences. It will also prevent buyers from accepting duplicate counter-RFSs generated by sellers. If the buyer proposes a counter-RFS 1530, the buyer enters the details of the counter-RFS 1532, which is sent to the central controller and the seller 1535. If the buyer declines the counter RFS, the RFS is moved to the cancelled RFS database 1550.

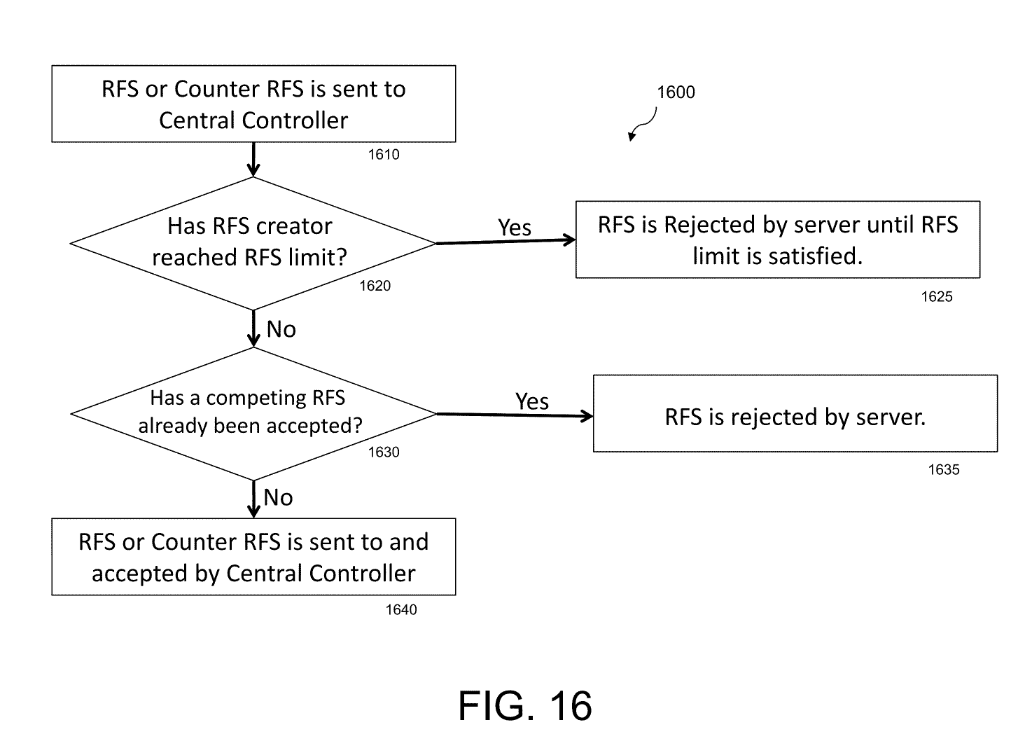

With reference to FIG. 16, there is shown a flow chart for the central controller's method of checking whether an RFS is acceptable 1600. An RFS or counter RFS is sent to the central controller 1610. If the RFS creator has reached the RFS limit 1620, the RFS is rejected by the server until the RFS limit is satisfied 1625. If a competing RFS has already been accepted, the RFS is rejected by the server 1635. If the RFS limit has not been reached and no competing RFS has been accepted, the RFS or counter RFS is sent to and accepted by the controller 1640.

In a detailed aspect of an exemplary embodiment, all interactions between buyer and seller are anonymous until the RFS has been accepted by both parties, and then information is sent about one party to the other.

It should be appreciated from the foregoing that the present invention provides a system and related method for generating and finalizing a request for sale. A request for sale is a non-binding agreement to purchase terms and product features. As such, the buyer does not have to enter credit card information or otherwise finalize the deal until they meet with the seller. The creation and acceptance of a request for sale is done largely by users as opposed to being automated. As such, buyers and sellers can use discretion when weighing the various factors involved in the purchase.

Although the invention has been disclosed in detail with reference only to the exemplary embodiments, those skilled in the art will appreciate that various other embodiments can be provided without departing from the scope of the invention. Accordingly, the invention is defined only by the claims set forth below.

What is claimed is:

1. A method using a computer system for generating and finalizing a request for sale (RFS) for a product, comprising:
obtaining from an RFS database an RFS from a user for a product, the RFS comprising a product identifier and purchase terms for binding the user to a purchase;
analyzing the RFS, via a computer processor, to match the RFS to a subset of sellers of the product based upon prescribed parameters;
providing the RFS to the subset of sellers, via digital communications, so that the subset of seller can elect to accept the RFS, provide a counter offer to the RFS, or decline the RFS, wherein the election is only open for a prescribed time;
binding the user and a seller of the subset of sellers that elects to accept the RFS under the terms of the accepted RFS, thereafter inhibiting the user from receiving any counter offer to the RFS via the system; and
wherein if none of the subset of sellers accepts the RFS, and if the user accepts a counter RFS from a seller of the subset of sellers, binding the user and the seller to the terms of the accepted counter RFS.

2. A method as defined in claim 1, wherein the providing step further includes providing credit information for the user along with the RFS.

3. A method as defined in claim 2, wherein the credit information is based upon a credit check authorized by the user.

4. A method as defined in claim 1, wherein the product is an automobile and the RFS includes lease terms, including monthly payment, annual mileage, and lease duration.

5. A method as defined in claim 1, wherein the product is an automobile and the counter RFS includes an automobile having one or more alternative features than those identified in the RFS.

6. A method as defined in claim 1, wherein a seller can create a counter-RFS by suggesting different sale terms and/or product features.

7. A method as defined in claim 1, wherein a seller dashboard allows a seller to accept a RFS, counter a RFS, or ignore a RFS.

8. A method as defined in claim 1, wherein a user is limited in the number of RFSs that can be submitted.

9. A method as defined in claim 1, wherein once a seller has accepted an RFS and/or a buyer has accepted a counter-RFS, the RFS is no longer sent to other sellers and a non-binding agreement to purchase terms is finalized between the buyer and the seller.

10. A computerized system for generating and finalizing a request for sale (RFS) for a product, comprising:
a database assembly;
a processor assembly in digital communication with the database assembly configured to perform the following steps:
obtaining from an RFS database an RFS from a user for a product, the RFS comprising a product identifier and purchase terms for binding the user to a purchase;
analyzing the RFS, via a computer processor, to match the RFS to a subset of sellers of the product based upon prescribed parameters;
providing the RFS to the subset of sellers, via digital communications, so that the subset of seller can elect to accept the RFS, provide a counter offer to the RFS, or decline the RFS, wherein the election is only open for a prescribed time;
binding the user and a seller of the subset of sellers that elects to accept the RFS under the terms of the accepted RFS, thereafter inhibiting the user from receiving any counter offer to the RFS via the system; and
wherein if none of the subset of sellers accepts the RFS, and if the user accepts a counter RFS from a seller of the subset of sellers, binding the user and the seller to the terms of the accepted counter RFS.

11. A system as defined in claim 10, wherein the providing step further includes providing credit information for the user along with the RFS.

12. A system as defined in claim 11, wherein the credit information is based upon a credit check authorized by the user.

13. A system as defined in claim 10, wherein the product is an automobile and the RFS includes lease terms, including monthly payment, annual mileage, and lease duration.

14. A system as defined in claim 10, wherein the product is an automobile and the counter RFS includes an automobile having one or more alternative features than those identified in the RFS.

15. A system as defined in claim 10, wherein a seller can create a counter-RFS by suggesting different sale terms and/or product features.

16. A system as defined in claim 10, wherein a seller dashboard allows a seller to accept a RFS, counter a RFS, or ignore a RFS.

17. A system as defined in claim 10, wherein a user is limited in the number of RFSs that can be submitted.

18. A system as defined in claim 10, wherein once a seller has accepted an RFS and/or a buyer has accepted a counter-RFS, the RFS is no longer sent to other sellers and a non-binding agreement to purchase terms is finalized between the buyer and the seller.
